(19) United States
(12) Patent Application Publication
(10) Pub. No.: US 2023/0146105 A1
(43) Pub. Date: May 11, 2023

(54) KNOWLEDGE INFORMATION CREATION ASSIST APPARATUS

(71) Applicants: KABUSHIKI KAISHA TOSHIBA, Minato-ku, Tokyo (JP); TOSHIBA DIGITAL SOLUTIONS CORPORATION, Kawasaki-shi, Kanagawa (JP)

(72) Inventors: Yoshikata TOBITA, Nishitokyo, Tokyo (JP); Masaru SUZUKI, Kawasaki, Kanagawa (JP); Satoshi SONOH, Chigasaki, Kanagawa (JP); Kentaro FURIHATA, Kawasaki, Kanagawa (JP); Guowei ZU, Hachioji, Tokyo (JP); Akihiro MURASE, Fuchu, Tokyo (JP)

(73) Assignees: KABUSHIKI KAISHA TOSHIBA, Minato-ku, Tokyo (JP); TOSHIBA DIGITAL SOLUTIONS CORPORATION, Kawasaki-shi, Kanagawa (JP)

(21) Appl. No.: 17/913,281

(22) PCT Filed: Mar. 16, 2021
(86) PCT No.: PCT/JP2021/010479

§ 371 Date: Sep. 21, 2022

(30) Foreign Application Priority Data
Mar. 27, 2020 (JP) 2020-057551

(51) Int. Cl. G06F 40/40; G06N 5/022; G06F 16/35; G06F 16/383; G06F 3/0484; G06F 40/242; G06F 40/166; G06F 40/279

(52) U.S. Cl. CPC G06F 40/40; G06F 3/0484; G06F 16/35; G06F 16/383; G06F 40/166; G06F 40/242; G06F 40/279; G06N 5/022

(57) ABSTRACT

A knowledge information creation assist apparatus allowing knowledge information such as FAQs to be created from user support histories accumulated in the past with a reduced workload. A knowledge information creation assist apparatus performs processing of removing at least one unnecessary utterance sentence not related to questioning from a plurality of user support histories including input questions or processing of extracting at least one utterance sentence related to questioning from the user support histories and grouping processing of classifying the user support histories output as the result of the processing into a plurality of question groups according to a predetermined classification model. The knowledge information creation assist apparatus displays group information of each of the question groups on a question group creation screen and performs control to produce knowledge information in response to input performed by a creator to one of the question groups selected on the question group creation screen.

### TECHNICAL FIELD

Embodiments of the present invention relate to a technique for assisting creation of knowledge information such as FAQs.

### BACKGROUND ART

Techniques for assisting interactions by means of FAQs have conventionally been used. FAQs or frequently asked questions are combinations of questions and answers created, for example, from user support histories. FAQs are used by operators serving users in contact centers or are put on websites as a guidance tool for users to find answers of questions or solutions of problems.

### Prior Art Documents

### Patent Documents

[Patent Document 1] Japanese Patent No. 4081065
[Patent Document 2] Japanese Patent No. 6200602

### DISCLOSURE OF THE INVENTION

### Problems to Be Solved by the Invention

It is an object of the present invention to provide a knowledge information creation assist apparatus allowing knowledge information such as FAQs to be created from user support histories accumulated in the past with a reduced workload.

### Means for Solving the Problems

According to an embodiment, a knowledge information creation assist apparatus provides a function of assisting creation of knowledge information related to questioning. The knowledge information creation assist apparatus includes: an input control section configured to control upload of a plurality of user support histories including questions; a question utterance extraction section configured to perform processing of removing at least one unnecessary utterance sentence not related to questioning from the uploaded user support histories or processing of extracting at least one utterance sentence related to questioning from the user support histories and then output the resulting user support histories as a result of the processing; a grouping control section configured to classify the user support histories output as the result of the processing from the question utterance extraction section into a plurality of question groups according to a predetermined classification model; and a screen control section configured to perform first display control for displaying, on a display apparatus, a question group creation screen including group information of each of the question groups and second display control for displaying, on the display apparatus, a knowledge information creation screen for producing knowledge information in response to input performed by a creator to one of the question groups selected on the question group creation screen.

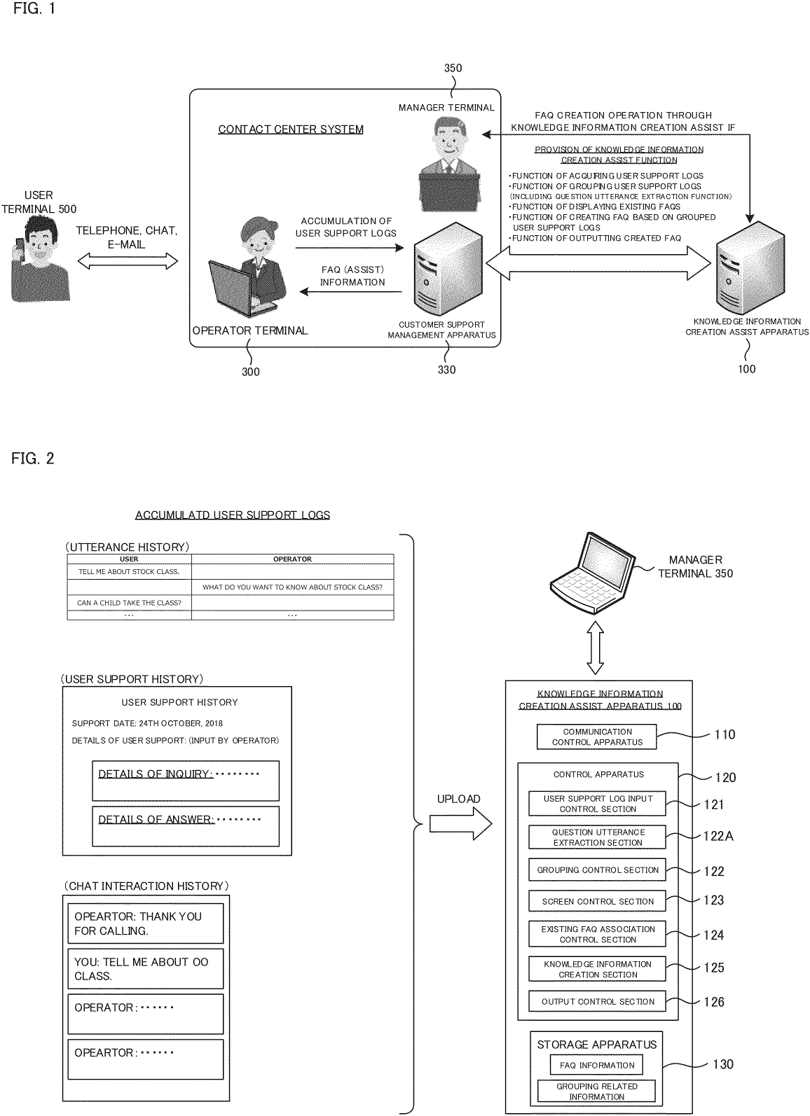

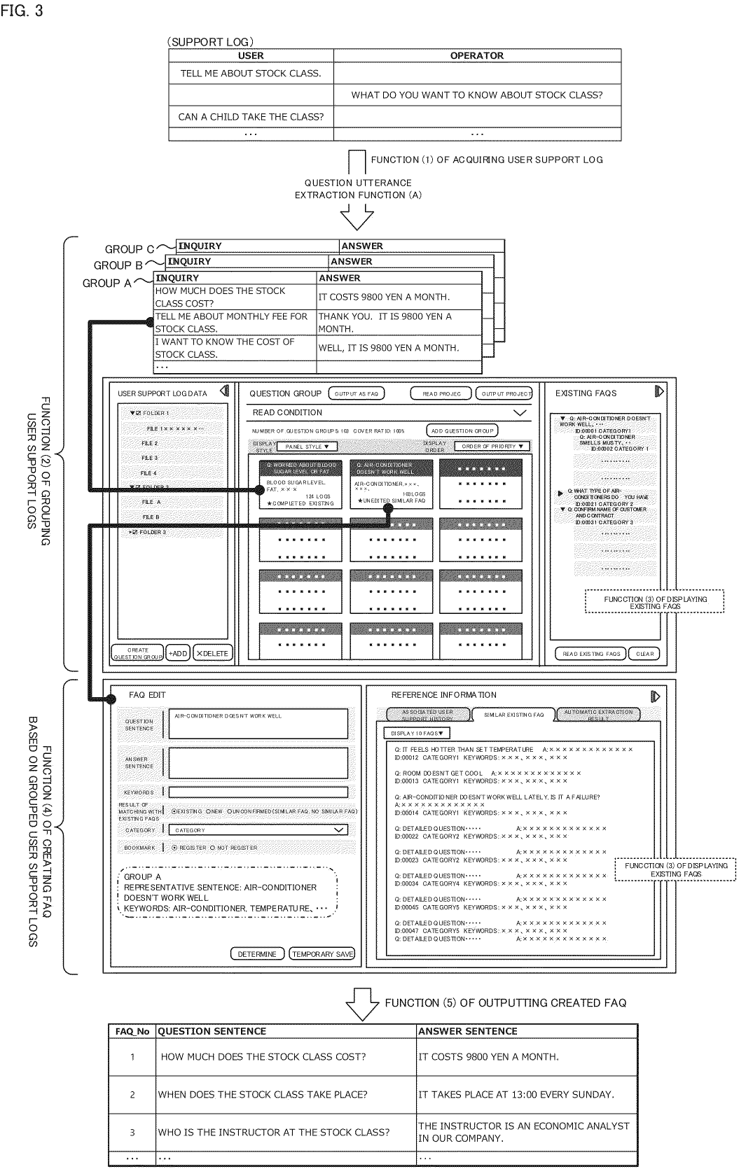

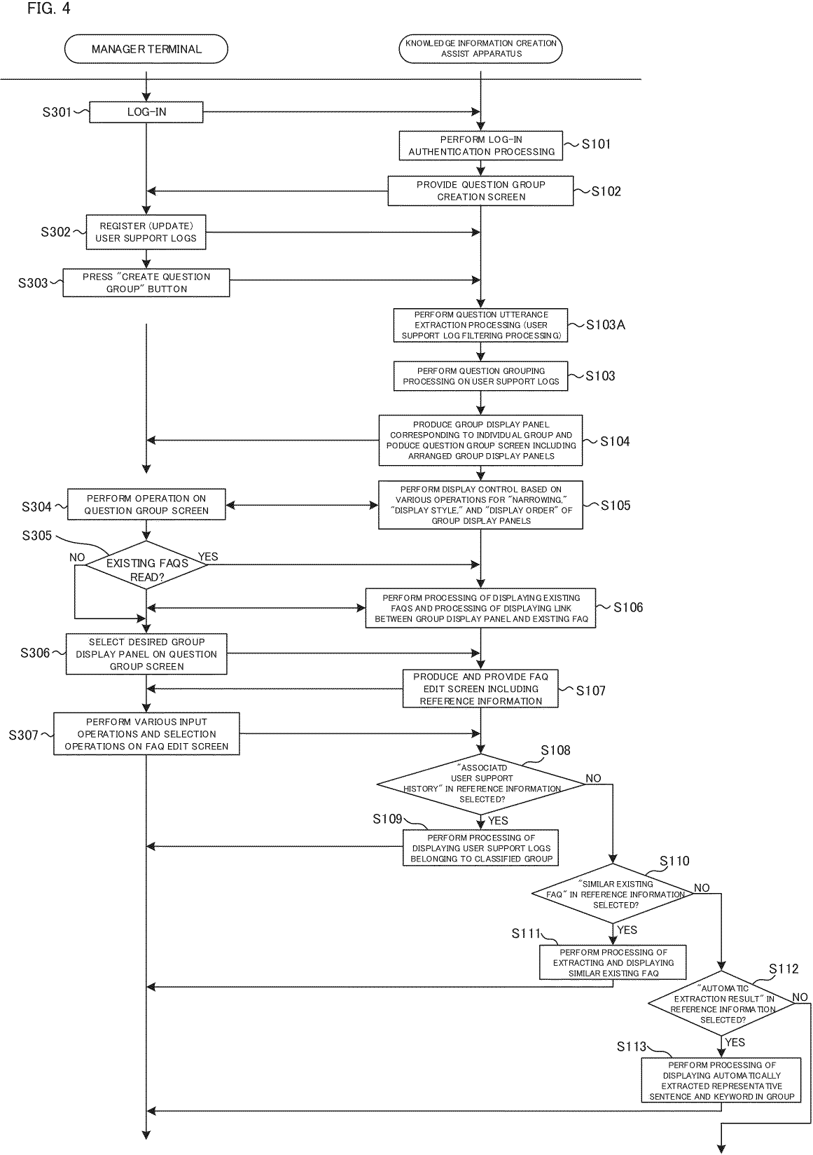

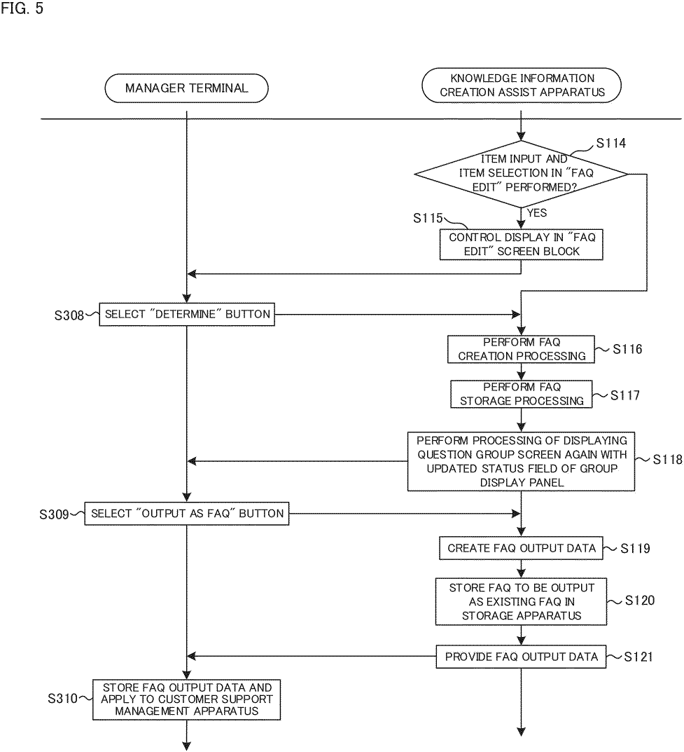

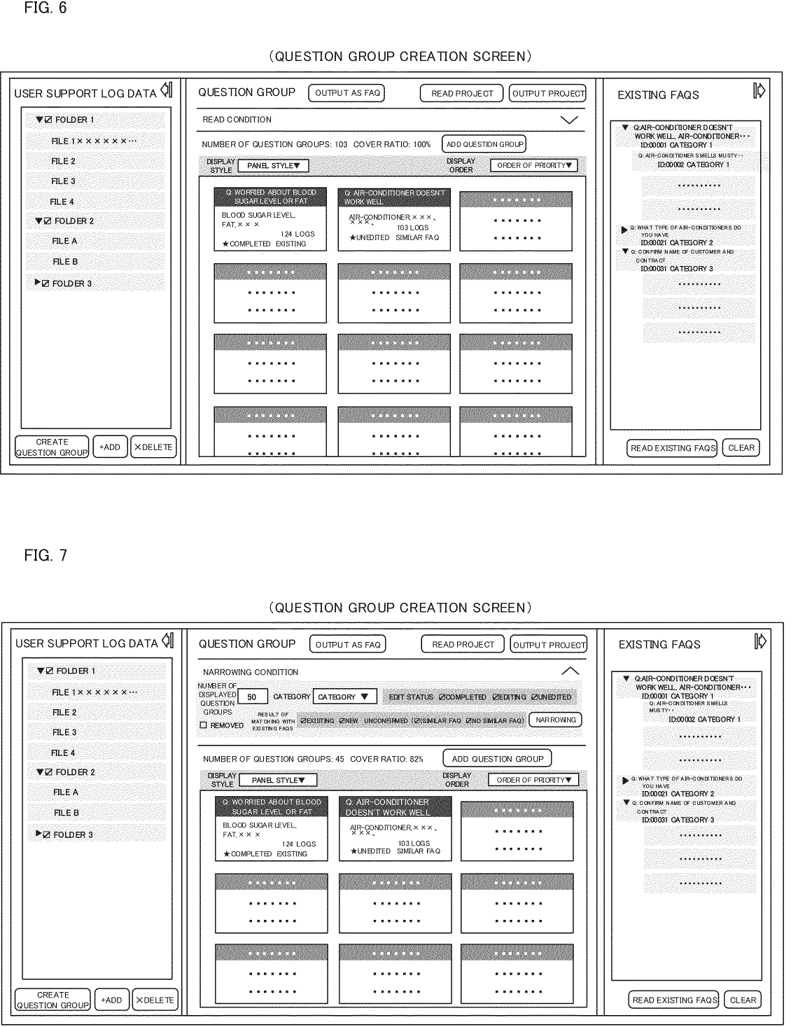

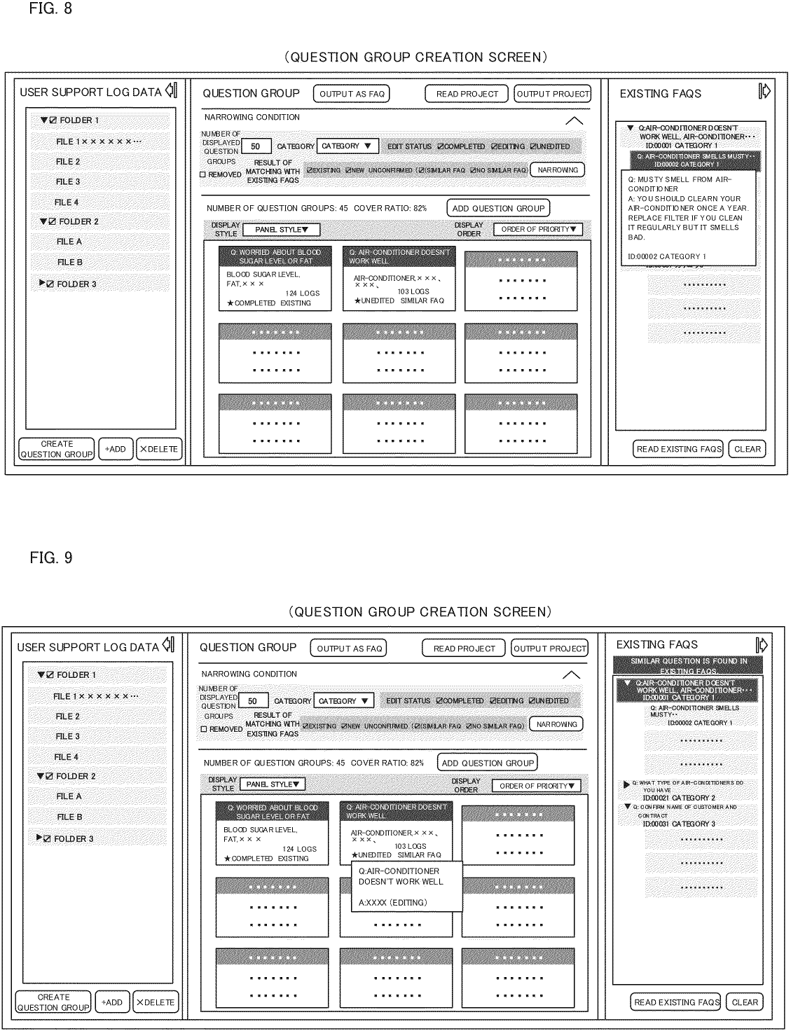

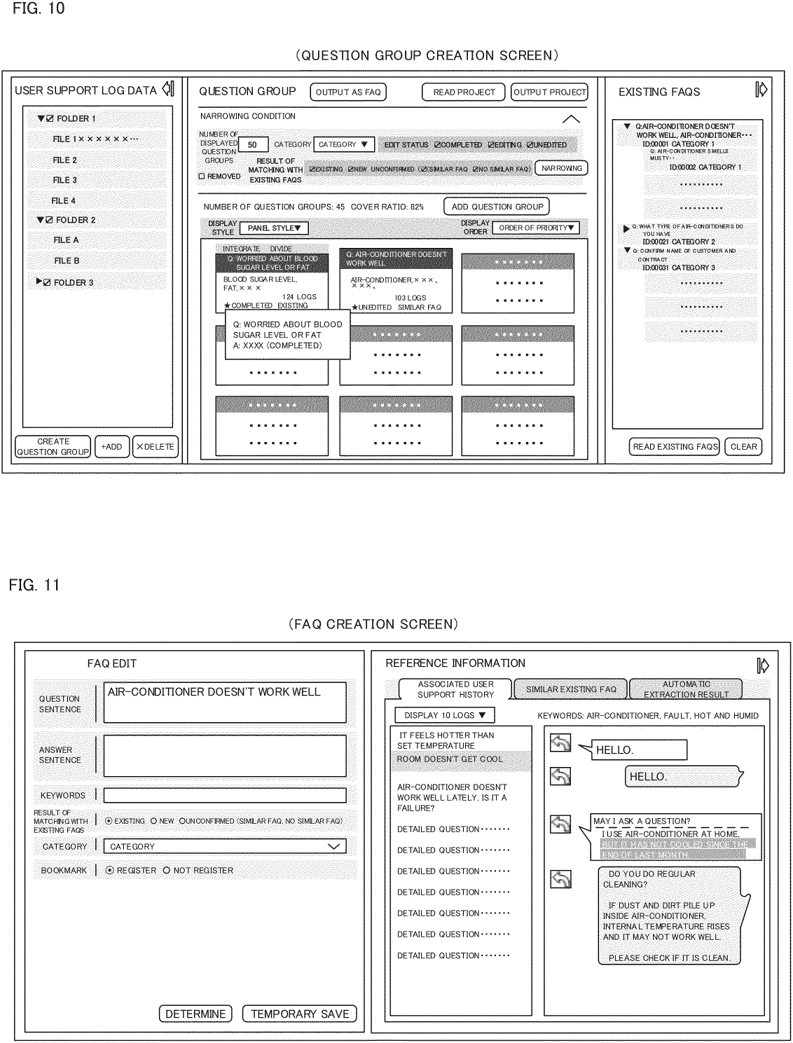

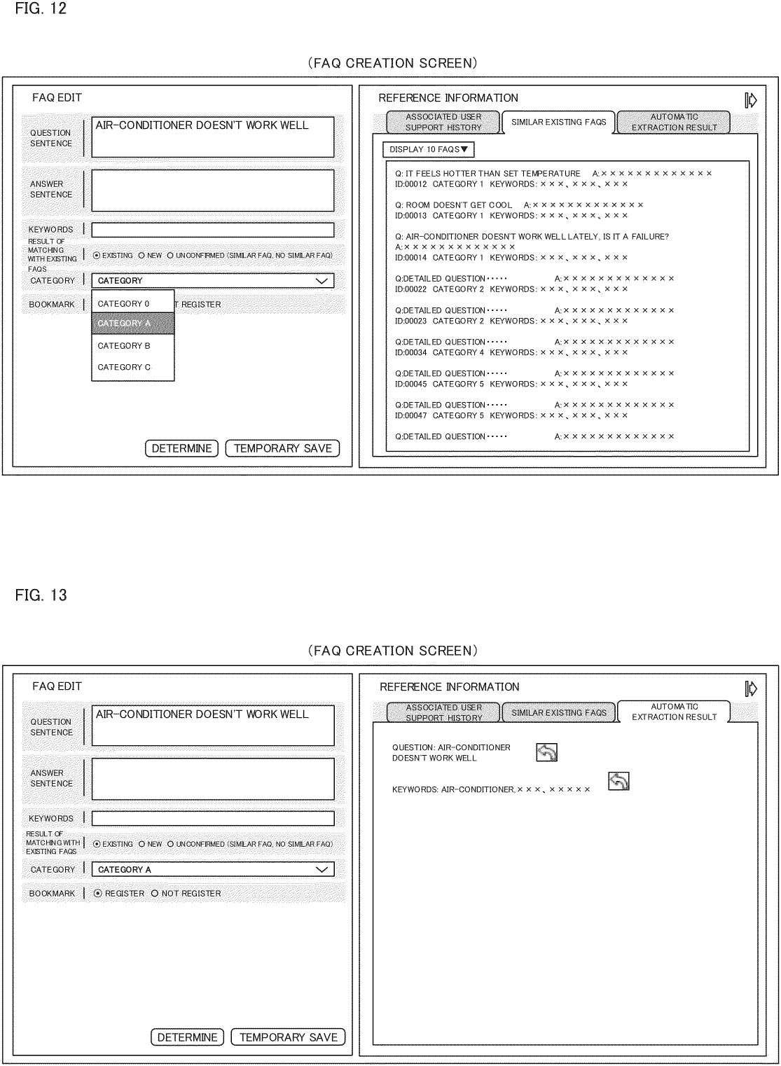

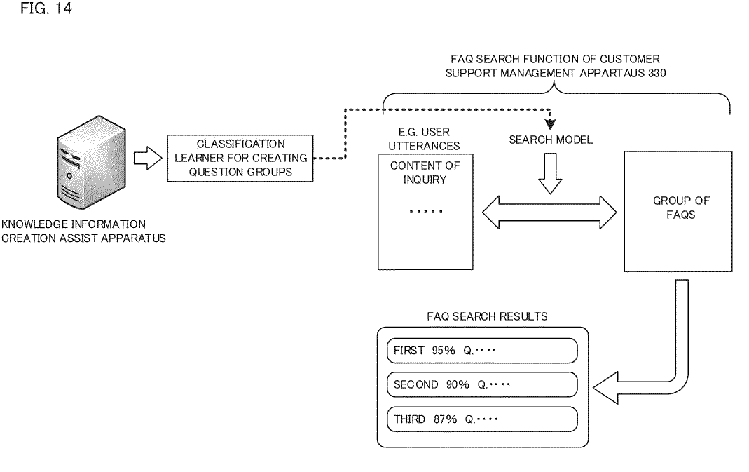

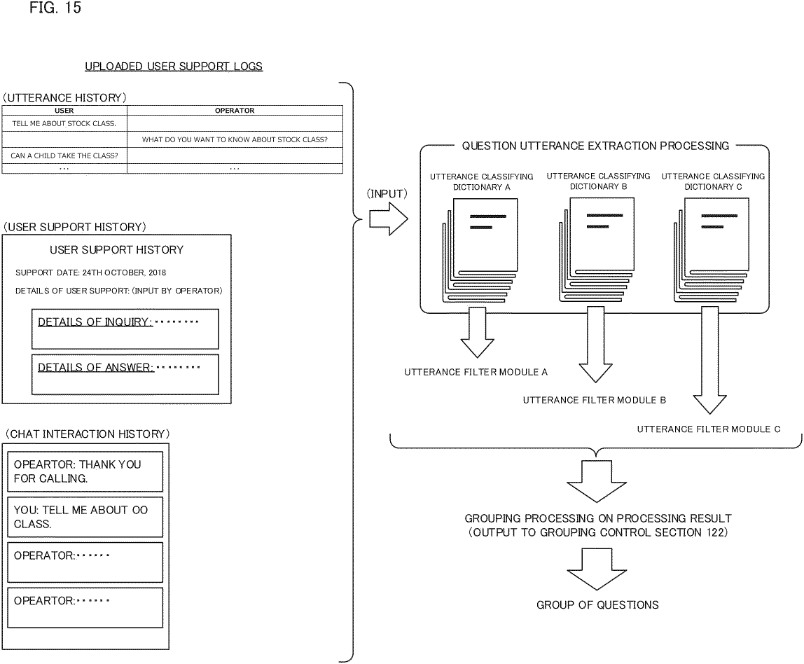

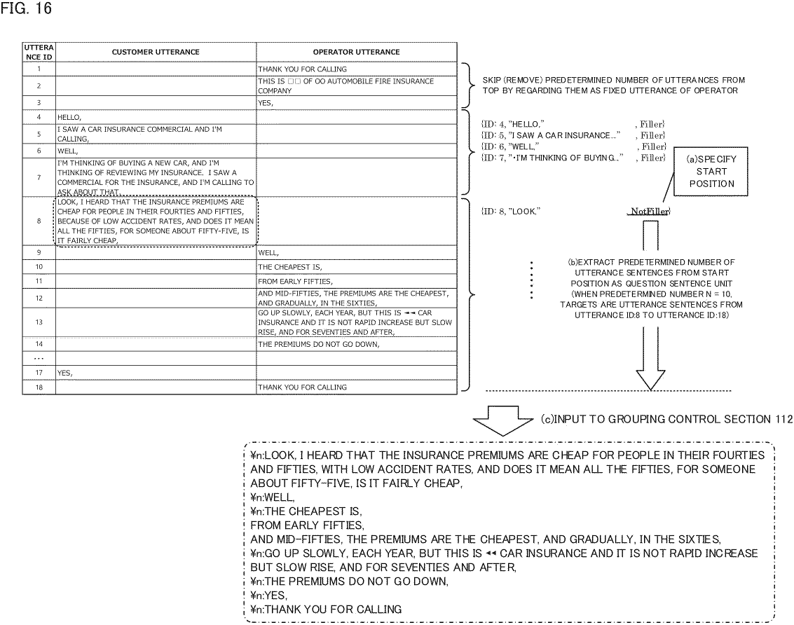

### BRIEF DESCRIPTION OF THE DRAWINGS

[FIG. 1] A schematic diagram showing a computer system to which a knowledge information creation assist apparatus according to Embodiment 1 of the present invention is applied.

[FIG. 2] A diagram showing the functional blocks of the knowledge information creation assist apparatus and an example of accumulated user support logs according to Embodiment 1.

[FIG. 3] A diagram for explaining an assist function provided by the knowledge information creation assist apparatus according to Embodiment 1.

[FIG. 4] A flow chart showing a knowledge information creation procedure in which the knowledge information creation assist apparatus according to Embodiment 1 is used.

[FIG. 5] A flow chart showing the knowledge information creation procedure subsequent to that shown in FIG. 4.

[FIG. 6] A diagram showing an example of a question group creation screen according to Embodiment 1.

[FIG. 7] A diagram showing an example of display resulting from narrowing condition processing on the question group creation screen according to Embodiment 1.

[FIG. 8] A diagram showing how read existing FAQs are displayed on the question group creation screen according to Embodiment 1.

[FIG. 9] A diagram showing an example of display control for a link (association) between a group display panel and an existing FAQ on the question group creation screen according to Embodiment 1.

[FIG. 10] A diagram showing an example of display control for group display panels on the question group creation screen according to Embodiment 1.

[FIG. 11] A diagram showing an example of an FAQ creation screen including an edit screen block and a reference information block according to Embodiment 1 and showing an example of display of “associated user support log” in the reference information block.

[FIG. 12] A diagram showing an example of the FAQ creation screen including the edit screen block and the reference information block according to Embodiment 1 and showing an example of display of “similar existing FAQ” in the reference information block.

[FIG. 13] A diagram showing an example of the FAQ creation screen including the edit screen block and the reference information block according to Embodiment 1 and showing an example of display of “automatic extraction result” in the reference information block.

[FIG. 14] A diagram showing an example in which a grouping model used in the knowledge information creation assist function according to Embodiment 1 is applied to an FAQ search function in a contact center.

[FIG. 15] A diagram for explaining question utterance extraction processing according to Embodiment 1.

[FIG. 16] A diagram showing an example of the question utterance extraction processing performed on a user support log according to Embodiment 1.

### MODE FOR CARRYING OUT THE INVENTION

An embodiment of the present invention will be described with reference to the accompanying drawings.

### Embodiment 1

FIGS. 1 to 16 are diagrams showing a knowledge information creation assist system according to Embodiment 1. FIG. 1 is a diagram showing the configuration of a computer system to which a knowledge information creation assist apparatus 100 according to Embodiment 1 (hereinafter referred to as an assist apparatus) is applied.

An example of knowledge information is FAQs (Frequently Asked Questions), and the FAQs are formed of combinations of questions and answers (the combinations of questions and answers do not necessarily have one-to-one correspondence but may have one-to-n or n-to-one correspondence). As described above, the FAQs can be used by operators serving users in contact centers to achieve efficient responses to users, thereby streamlining the operation in contact centers. The FAQs can also be put on websites to help users solve their questions or problems with reference to the FAQs, which can enhance convenience of users and can reduce the number of inquiries (the number of incoming calls) in contact centers.

In general, the FAQs are often created by managers based on a large amount of user support logs accumulated in the past (user support histories), and involves a significant burden and cost in creation and maintenance (update). Since all the large amount of user support logs cannot be reviewed, the quality of the FAQs may depend on the managers.

To reduce the burden of creation and maintenance of the FAQs, techniques have been proposed for automatically classifying user support logs to automatically create optimal FAQs (For example, see Patent Documents 1, 2). However, the automatically created FAQs cannot necessarily be put to practical use as they are. In reality, those FAQs are corrected by managers, or in some cases, FAQs end up being created based on manual operation.

To address this, the assist apparatus 100 according to Embodiment 1 provides an environment in which FAQs can be created manually from a large amount of user support logs without cumbersome operation. Specifically, the assist apparatus 100 provides the following principal functions of assisting creation of knowledge information through a user interface function:
(1) a function of acquiring (uploading) user support logs;
(2) a function of grouping and an displaying the user support logs;
(3) a function of reading and displaying existing FAQs;
(4) a function of creating an FAQ based on the grouped user support logs; and
(5) a function of outputting the created FAQ.

The assist apparatus also provides (A) a function of extracting question utterances (function of filtering question utterances) performed before the grouping (2) of the user support logs. The details of the question utterance extraction function will be described later.

First, description is made of an example of accumulation of user support logs and use of FAQs in conjunction with the example shown in FIG. 1.

In a contact center system, an operator interacts with a user via telephone (call), chat, or e-mail to answer a question (inquiry) from the user. A user support log in which the interaction is recorded is managed and accumulated in a customer support management apparatus 330. The customer support management apparatus 330 can be used to provide a function of assisting the operator in user support and perform processing of providing FAQs through an FAQ search function.

The customer support management apparatus 330 can accumulate the user support log, for example, in an operator input mode in which a predetermined input screen is displayed on an operator terminal 300 to allow the operator to input the user support log (mainly the content of the question and the answer).

Alternatively, the content of voice interaction with the user via a user terminal 500 can be converted into text through voice recognition and the text can be compared with existing FAQs to retrieve and display any FAQ appropriate for the content of the interaction on a display apparatus of the operator terminal 300. The same applies to chat, in which case the content of interaction through time-series text messages can be used to retrieve and display any existing FAQ appropriate for that content. In this case, the customer support management apparatus 330 can automatically manage and accumulate the series of interactions in text form as a user support log (automatic input mode).

In addition to the automatic search mode involving automatic matching with the content of interaction, the FAQ search function includes, for example, a manual search mode in which the operator inputs a keyword to perform manual search on an FAQ search screen and then any suitable existing FAQ is displayed as the result of the search. In the manual search mode, the operator can also search a list of existing FAQs to retrieve and display any suitable FAQ by himself. The FAQ search function can allow both of the automatic search mode and the manual search mode.

In the automatic search mode described above, the matching between the content of interaction and the FAQs can be performed by means of a query model and a search model using a classification learner. The classification learner adopts various techniques, and for example, can quantify (weight) individual words in a document based on the number of appearances or the similarity between the words to utilize a known technique such as a Naive Bayes classifier which is one of classification techniques in machine learning. The classification technique is not limited to the Naive Bayes classifier, and other known techniques may be used.

The query model is, for example, a classification learner which is trained to extract a sentence intended to question from a group of sentences. The search model is a classification learner which is trained to extract an FAQ (answer) appropriate for the sentence (question) extracted in the query model. Since the techniques for grouping and sorting sentences using the classification learner (model) are known technologies, detailed description thereof is omitted.

While the following description is made of FAQ creation assist based on the user support logs accumulated in the single contact center, the present invention is applicable in an aspect in which contact centers are deployed in a plurality of sites. For example, the assist apparatus 100 can be connected to each of the contact centers (customer support management apparatuses 330) in those sites over a network and acquire user support logs from the contact centers to create FAQs. In this case, the assist apparatus 100 can create an integrated FAQ from the plurality of sites or create a different FAQ for each site.

In this manner, the customer support management apparatus 330 accumulates user support logs on a daily basis and provides user support using FAQs. A manager can extract and upload a plurality of user support logs from the customer support management apparatus 330 to the assist apparatus 100 according to Embodiment 1 to create an FAQ through the use of the knowledge information creation assist function. The created FAQ can be output in a predetermined data format (for example, a CSV format). The output FAQ information can be input to the customer support management apparatus 330 and used for user support based on FAQs (including putting the FAQ information on a website).

FIG. 2 is a diagram showing the functional blocks of the assist apparatus 100 and an example of the accumulated user support logs. The assist apparatus 100 includes a communication control apparatus 110, a control apparatus 120, and a storage apparatus 130. The communication control apparatus 110 performs processing of connection and data communication with the manager terminal 350 or the customer support management apparatus 330 via networks such as the Internet or a predetermined dedicated network. The storage apparatus 130 stores the uploaded user support logs or created FAQ information (existing FAQs), or stores various types of information including the classification learner (model) for use in the grouping function as grouping related information.

The control apparatus 120 includes a user support log input control section 121, a grouping control section 122, a screen control section 123, an existing FAQ association control section 124, a knowledge information creation section 125, an output control section 126, and a question utterance extraction section 122A.

The user support logs are formed of combinations of questions and answers and are included in an utterance history from interactions between users and operators, a user support history in the operator input mode, a chat interaction history and the like. It should be noted that questions and answers may not be unambiguously determined such that the question is what a user says and the answer is what an operator says. Thus, the “question” may include what an operator says when he repeats a user’s question or says it in other words.

The utterance history includes text data created from voice interactions between users and operators through voice recognition processing, and can be accumulated separately in user’s utterances and operator’s utterances as shown in FIG. 2. The user support history includes user support logs input by operators in the operator input mode on the predetermined input screen described above. The chat interaction history includes a series of interactions in text form as described above.

These user support logs are created by the customer support management apparatus 330. The voice recognition processing can be performed by a voice recognition processing section incorporated in the customer support management apparatus 330 or an external voice recognition processing server.

A user support log file uploaded to the assist apparatus 100 may correspond to data (file) from a single user support interaction or from a different one of operators, or may be file data including a plurality of user support logs provided by collecting all user supports. A plurality of questions may be included in each of the utterance history, the user support history, and the chat interaction history. For example, in an interaction between a user and an operator, the user may ask questions in succession over time, and the operator may successively answer the questions. As a result, each of the histories may include a plurality of user support logs (a plurality of questions and answers).

FIG. 3 is a diagram for explaining the assist function provided by the assist apparatus 100. First, the function (1) of acquiring (uploading) user support logs includes processing of receiving, from the manager terminal 350 (or an external storage apparatus connected to the manager terminal 350), a user support log file of the CSV format including question and answer sentences in the form of text data and storing the received file in the assist apparatus 100. The function (1) is performed by the user support log input control section 121. A plurality of user support log files may be acquired together.

The question utterance extraction section 122A performs question utterance filtering processing on the acquired user support log file. The question utterance filtering processing includes removing any utterance corresponding to a filler (an utterance element which is meaningless in itself but is used to fill a gap between utterances or to probe or get the hint of the reaction of an interaction partner) or a greeting included in the user support file to extract a group of utterances consisting mainly of question sentences. The grouping processing is performed on the result of the question utterance filtering processing.

Next, the function (2) of grouping and displaying the user support logs includes, with a predetermined classification leaner, grouping “questions” found in the uploaded user support logs which have been subjected to the question utterance filtering processing (A). The grouping is performed in the manner described above. For example, words in question sentences can be quantified (weighted) based on the number of appearances or the similarity between the words to group similar question sentences or sentences having similar intention. The function (2) is performed by the grouping control section 122.

The grouping control section 122 can automatically extract a representative sentence (representative question sentence) and keyword(s) representative of each of the groups. The extracted representative sentence can be used as a group name.

The representative sentence and keyword(s) can be produced, for example, by scoring the number of appearances of each word or the similarity between words within the question sentences. Specifically, a word having a high number of appearances in the grouped question sentences can be extracted as a keyword, or the grouped question sentences can be evaluated with a query model to select (extract) a question sentence having a high evaluation level as a representative sentence.

The result of the grouping is displayed on a screen as group information. Existing FAQs can be displayed together with the result of the grouping. The function (3) of reading and displaying existing FAQs includes displaying already created FAQs (already created knowledge information) created previously (in the past) with the knowledge information creation assist function and/or created previously without the knowledge information creation assist function. The function (3) is performed by the existing FAQ association control section 124 which reads the existing FAQs previously stored in the storage apparatus 130 and displays the read FAQs on the screen together with the result of the grouping. As described later, the existing FAQ association control section 124 can also perform processing of association display in response to operation on the screen such as emphasizing an existing FAQ similar to any of the questions in the groups.

The function (4) of creating an FAQ based on the result of the grouping includes selecting group information (for example, group display panel) resulting from the grouping and creating an FAQ from the group information. In response to selection of group information, an FAQ creation screen (knowledge information creation screen) is displayed. On the FAQ creation screen, an FAQ can be created based on input operation performed by the manager (operator).

On the FAQ creation screen, an FAQ edit screen block and a reference information display block are displayed side by side. With reference to information in the reference information display block, the manager performs input and edit in the FAQ edit screen block. The manager can select a “determine” button to create (produce) one FAQ belonging to one group. The created FAQ is assigned predetermined FAQ identification information (FAQ_No) and stored in the storage apparatus 130. The FAQ edit and creation processing is performed by the knowledge information creation section 125.

The function (5) of outputting the created FAQ includes outputting, in the CSV format, the FAQ assigned unique FAQ identification information stored in the storage apparatus 130. In response to selection of a predetermined “output as FAQ” button, the output control section 126 converts the FAQ into an output file of the CSV format and transmits the file to the manager terminal 350.

The output control section 126 can perform control to output only the newly created FAQ, that is, the difference from the existing FAQs, or to output all the FAQs including the newly created FAQ as an existing FAQ. Any output range of FAQs may also be set. The output format is not limited to the CSV format, and for example, any data format may be used as long as the customer support management apparatus 330 can acquire the data.

The screen control section 123 controls the overall display on the screens where the functions (1) to (5) are provided. The display control for the individual functions can be performed by the associated functional sections, and those functional sections cooperate with the screen control section 123 to control the overall display processing.

### Description of Processing of Knowledge Information Creation Assist Function and Screen Control

FIGS. 4 and 5 are diagrams showing a processing flow for performing the knowledge information creation assist function provided by the assist apparatus 100. FIG. 5 is a flow chart subsequent to that in FIG. 4. FIGS. 6 to 13 are diagrams showing examples of the screens for use in the knowledge information creation assist function and display control.

First, the manager connects to the customer support management apparatus 330 from the manager terminal 350 and extracts user support logs including question and answer sentences in the form of text data. The customer support management apparatus 330 can have a function of outputting the user support logs in the CSV format, for example. A user support log file corresponds to data including a plurality of user support logs.

As shown in FIG. 4, the manager connects to the assist apparatus 100 from the manager terminal 350 and logs in to use the knowledge information creation assist function (S301). The assist apparatus 100 receives input of a previously issued (registered) user ID and password to perform log-in authentication (S101). If the log-in authentication succeeds, the assist apparatus 100 transmits a question group creation screen to the manager terminal 350 which in turn displays the screen (S102).

FIG. 6 is a diagram showing an example of the question group creation screen. The question group creation screen includes a user support log data display block, a question group display block, and an existing FAQ display block. The manager selects an “add” button to specify any user support log file to be uploaded in the user support log data display block. The specified user support log file is transmitted from the manager terminal 350 to the assist apparatus 100 and stored in the storage apparatus 130, and the file name of the user support log file is displayed within the list in the user support log data display block (S302). To remove any file from the user support log files intended for use in creating question groups, a “delete” button can be pressed to remove (delete) the file.

The user support log data display block includes a “create question group” button. The manager can select the “create question group” button (S303) to create a question group from any user support log file (a plurality of user support logs) displayed within the list in the user support log data display block.

In Embodiment 1, the question utterance filtering processing is performed on the user support log file to be processed by the grouping control section 122 to remove any utterance corresponding to a filler or a greeting included in the user support log file (S103A). Then, the grouping control section 122 performs grouping processing on the user support log file including a group of utterances consisting mainly of question sentences from which the unnecessary utterance phrases and sentences have been removed.

The grouping control section 122 performs question grouping processing on the one or more uploaded user support log files which have been subjected to the question utterance filtering processing by grouping the questions included in the user support logs through the use of the classification learner described above (S103). The screen control section 123 displays the resulting question group in the question group creation display block.

The grouping control section 122 counts the user support logs included in one question group. The grouping control section 122 performs processing of extracting a representative sentence and keyword(s). The question group name (or group ID), the number of belonging user support logs, and the representative sentence and keyword(s) are stored in the storage apparatus 130 as grouping related information for each question group. The grouping control section 122 creates information indicating the correspondence between each question group and the belonging user support logs and stores the information in the storage apparatus 130. For example, each question group can be associated with the IDs of the user support logs, or each group name (group ID) can be associated with the user support logs.

After the grouping processing, the screen control section 123 creates question group display information including at least the representative sentence, the number of belonging user support logs, and the keyword(s), and displays the created information in the question group creation display block (S104). An example of the question group display information is group display panels in the form of rectangular icons as shown in FIG. 6. Alternatively, question groups may be displayed in rows of a table.

The question group creation display block is now described. In the question group creation display block, the manager can select one of display styles including list and panel styles and display the question groups in the selected style (S304). The example of FIG. 6 shows an aspect in which the panel style is selected, and a plurality of group display panels are arranged. The order of display of the plurality of question groups may also be specified (S304). The order of display may be based on the priority (bookmark registration) given to each question group, the number of user support logs included in each question group or the like. The screen control section 123 controls the manner of display of the question groups according to the selected display style or the display order (S105).

The number of question groups and a cover ratio are displayed in the question group creation display block. The cover ratio refers to the ratio of the total number of the user support logs belonging to the groups displayed in the question group creation display block to the total number of the user support logs uploaded to the user support log data display block. In the example of FIG. 6, the cover ratio of 100% is displayed since the total number of the user support logs in all the displayed question groups is consistent with the total number of the user support logs uploaded to the user support log data display block.

With the cover ratio calculated and displayed in this manner, it is possible to know how many user support logs can be covered by the question groups which have been narrowed down, or in other words, to know how many question groups are needed to cover all the user support logs. Specifically, as the number of question groups is increased, the number of created FAQs is increased, and an increased number of FAQs allows detailed support tailored to the individual needs of users. However, an extremely increased number of FAQs provides too many options in user support and is likely to offer FAQs which do not exactly fit the needs of users. Such an increased number of FAQs also puts a great burden on the operator searching FAQs. Thus, instead of simply creating an FAQ from each of all the question groups covering 100% of the user support logs, creating FAQs from a set of question groups which are low in number but high in cover ratio can achieve FAQs which are efficient and likely to fit the needs of users. In addition to the viewpoint of the number of user support logs, the cover ratio can be calculated while taking account of information about time taken for user support and operator information acquired from the customer support management apparatus 330. As a result, FAQs can be created from questions requiring longer times for answers by giving a higher priority to those questions, or FAQs can be created from user support logs including a highly regarded (experienced) operator by giving a higher priority to those user support logs.

FIG. 7 is a diagram showing an example of display resulting from narrowing condition processing on the question group creation screen. The question group creation display block has a narrowing condition specification field for specifying conditions such as the number of displayed question groups, category, edit status, removed, and result of matching with existing FAQs. The manager can specify any conditions in the narrowing condition specification field (S304). The screen control section 123 searches all the question groups for any question groups that satisfy the specified narrowing conditions and displays those question groups in the question group creation display block (S105).

In the example of FIG. 7, 45 of 103 question groups are displayed as a result of the narrowing processing. The cover ratio is 82%. This means that the 45 question groups constitute 82% of all the user support logs uploaded to the user support log data display block. It can be seen that the remaining 58 question groups not satisfying the narrowing conditions constitute 18% of all the user support logs.

The existing FAQ display block includes a “read existing FAQ” button. When the manager selects the “read existing FAQ” button, the existing FAQs stored in the storage apparatus 130 can be displayed (S305). FIG. 8 is a diagram showing how the read existing FAQs are displayed. In response to selection of the “read existing FAQ” button, the screen control section 123 performs control to display the existing FAQs in the existing FAQ display block and to pick up one of the FAQs pointed (selected) with a cursor in the existing FAQ display block and display the content of that FAQ in a separate window (S106).

As shown in FIG. 9, when the displayed existing FAQs include an FAQ having a question similar to the question of a question group selected in the question group creation display block, the screen control section 123 performs control to emphasize the similar FAQ such that it is linked to (associated with) the question group. For example, when a certain question group is pointed with a cursor, the existing FAQ association control section 124 determines the similarity between the question group and the existing FAQs and extracts any existing FAQ having a predetermined similarity level or more or an existing FAQ having the highest similarity level through the use of the classification learner used by the grouping control section 122 in creating the question groups. Then, the screen control section 123 can emphasize (for example, highlight) the similar FAQ extracted by the existing FAQ association control section 124 in the existing FAQ display block and display a message “similar question is found in existing FAQs,” for example.

FIG. 10 is a diagram showing an example of display control for the group display panels (question groups). In the example of FIG. 10, the group display panels are provided with “integrate” and “divide” buttons. When the “integrate” button is selected for a question group, the question group can be integrated with another question group. In response to selection of the “integrate” button, the grouping control section 122 integrates specified two or more question groups into one question group and stores the integrated group in the storage apparatus 130. The integrated new question group may employ a representative sentence and keyword(s) of one of the original two or more question groups as a representative sentence and keyword(s) of the new question group. Alternatively, the processing of extracting a representative sentence and keyword(s) may be performed again to update the grouping related information in the storage apparatus 130. The screen control section 123 performs display control for the integrated question group in the question group creation display block.

The “divide” button can be used to perform the question grouping processing again on user support logs included in a specified one of the question groups to create two or more question groups and stores them in the storage apparatus 130. The divided question groups are again subjected to the processing of extracting a representative sentence and keyword(s).

Next, the manager can select a question group to create an FAQ. When a group display panel is selected (S306), the screen control section 123 displays an FAQ creation screen shown in FIG. 11 on the manager terminal 350 (S107). An FAQ edit screen block on the FAQ creation screen has a question sentence input field, an answer sentence input field, and a keyword input field. As shown in FIG. 11, the screen control section 123 may perform control to automatically display a representative sentence in the question sentence input field.

The screen control section 123 controls input to each input field and also controls selection of selection items including a result of matching with existing FAQs, category, and bookmark (priority). The selection items are associated with the narrowing conditions described above, and are items manually setting by the manager.

A reference information display block on the FAQ creation screen has a plurality of tabs. The manager can select one of the tabs to display reference information linked thereto (S307). The example of FIG. 11 shows “associated user support history” displayed as reference information. In displaying the FAQ creation screen through screen transition from the question group creation screen, the screen control section 123 can perform control to automatically select a predetermined one of the plurality of tabs to display the linked reference information, or not to display any reference information until a tab is selected.

In the “associated user support history,” the user support logs belonging to the question group are displayed. The screen control section 123 can extract and display the belonging user support logs based on the correspondence between question groups and user support logs stored in the storage apparatus 130 (YES at S108, S109). As shown in FIG. 11, in the reference information display block, the screen control section 123 can perform control to display only the question sentences included in the user support logs on the left and display the original data included in a selected one of the user support logs on the right (for example, the utterance history including the utterances of the respective utterers arranged in chronological order).

FIG. 12 is a diagram showing an example of display of “similar existing FAQ” in the reference info3rmation display block. In the “similar existing FAQ,” the existing FAQs read on the question group creation screen are displayed (YES at S110, S111). FIG. 13 is a diagram showing an example of display of “automatic extraction result” in the reference information display block. In the “automatic extraction result,” the representative sentence and keyword(s) automatically extracted by the grouping control section 122 are displayed (YES at S112, S113).

With reference to various types of information in the reference information display block on the FAQ creation screen, the manager can input and edit a question sentence, input an answer sentence, and perform various selection operations of the selection items (S114, S115).

To create an FAQ from the combination of the input question sentence and answer sentence, the manager selects the “determine button” in the FAQ edit screen block (S308). In response to the selection of the “determine” button, the knowledge information creation section 125 assigns FAQ identification information (FAQ_No) to the set of the question sentence in the question sentence input field and the answer sentence in the answer sentence input field to create an FAQ (S116). The knowledge information creation section 125 stores the created FAQ in the storage apparatus 130 (S117).

After the creation of the FAQ on the FAQ creation screen, the screen control section 123 performs control to transition from the FAQ creation screen to the question group creation screen, thereby displaying the question group creation screen on the manager terminal 350. The screen control section 123 controls the display of the question group associated with the created FAQ such that the question group has the status updated to “created” (S118). For example, in the example of FIG. 6, “completed” is displayed in the group display panel. In a question group with no FAQ created, “unedited” can be displayed.

After the creation of the FAQ on the question group creation screen and the FAQ creation screen, the manager can output the FAQ for use in contact centers. In response to selection of the “output as FAQ” button” on the question group creation screen, the output control section 126 creates, for example, FAQ output data in the CSV format from the FAQ having the “created” status in the question groups displayed on the question group creation screen (S119). The output control section 126 can perform processing of updating the status of the FAQs stored in the storage apparatus 130 by setting the FAQ to be output as an existing FAQ (S120). With this configuration, the FAQ from the question group displayed on the present question group creation screen can be controlled not to be displayed as an existing FAQ and can be controlled to be displayed as an existing FAQ in the next creation processing.

The output control section 123 transmits the created FAQ output data to the manager terminal 350 (S121). The manager stores the FAQ downloaded from the assist apparatus 100 in the manager terminal 350 or the external storage apparatus. The manager then applies (acquires) the created FAQ to the customer support management apparatus 330 and utilizes the FAQ for support operations in the contact center.

FIG. 14 is a conceptual diagram in which the question grouping model (classification learner) used in the knowledge information creation assist function according to Embodiment 1 is applied to an FAQ search function in a contact center. As shown in FIG. 14, a customer support management function in the contact center can have a function of searching for an appropriate FAQ based on the content of interactions in text form provided through voice recognition. The FAQ search function uses the classification learner for searching for an FAQ having a question sentence similar to a question from a user. Thus, the question grouping model used in the knowledge information creation assist function according to Embodiment 1 can be applied to the customer support management apparatus 330. With this configuration, the question from the user can be associated with the original question group used in creating the FAQ, and the FAQ having the similar question content can be searched for accurately.

### Description of Question Utterance Extraction Processing

FIG. 15 is a diagram for explaining the question utterance extraction processing according to Embodiment 1. The question utterance extraction processing is preprocessing of the grouping processing performed by the grouping control section 122 and includes processing of removing unnecessary utterances sentence not related to questioning from the user support log file or processing of extracting only utterance sentences related to questioning from the user support log file. Both the former and latter produce the same result of the question utterance extraction processing. The grouping control section 122 performs the grouping processing on the user support logs which have been subjected to the question utterance extraction processing or the user support logs including one or more question units extracted through the question utterance extraction processing.

FIG. 16 is a diagram showing an example of the user support log and processing of the question utterance extraction function. By way of example, utterance texts of a customer and an operator in an interaction between them are arranged side by side and assigned sequence numbers as utterance IDs in chronological order.

As in the example of FIG. 16, utterances such as “Excuse me (utterance ID: 4)” and “..., as I’m calling (utterance ID: 5)” are fillers (an utterance element which is meaningless in itself but is used to fill a gap between utterances or to probe or get the hint of the reaction of an interaction partner) having no information (meaning) representing questioning (non-question utterances). In addition, most of back-channelings such as “well,” greetings, and responses to greetings are non-question utterances which do not have meanings serving as questions.

To identify the information related to questioning in the user support log file, an utterance classifying dictionary is used to distinguish utterances (non-question utterances) such as fillers and greetings having no information representing questioning from utterances having information representing questioning. One or more utterance sentences having information representing questioning are extracted and input to the grouping control section 122.

The utterance classifying dictionary includes a first library including accumulated words, keywords, and groups of exemplary utterances having no information representing questioning and a second library including accumulated words, keywords, and groups of exemplary utterances having information representing questioning. Each of the libraries can be formed as a customer utterance library or an operator utterance library. For example, customized libraries can be provided such that the characteristics of individual customers are taken into account by accumulating examples of utterances having no information representing questioning and examples of utterances often having information representing questioning which are frequently found in inquiries from the customers. Utterance classifying dictionaries can be created and updated for different business types, products, regions, or participants in interactions (customer or operator) using a well-known machine learning function. In addition to humans such as the operator, the computer-based interactive voice response (IVR) system can be regarded as an utterer in the user support history. In other words, the user support history including utterance sentences provided from the IVR system and users can be covered by the scope in which Embodiment 1 is implemented.

Specifically, as shown in FIG. 15, the question utterance extraction section 122A is combined with the utterance classifying dictionaries to form utterance filter modules, each of the modules being formed from a different one of the dictionaries. The utterance classifying dictionaries can be constructed and updated as libraries specific to utterers of customer utterances or operator utterances. The control apparatus 120 can set customized modules such as a customer utterance filter module and an operator utterance filter module. The customer utterance filter module and the operator utterance filter module may be integrated into one module, and the one module may be associated with a plurality of libraries. For example, a contact center utterance filter module can be set to be associated with two libraries including the customer utterance classifying dictionary and the operator utterance classifying dictionary.

This modular configuration can ensure independence between the modules and association between the modules to customize the question utterance extraction function with ease and at low cost appropriately for different business types, products, regions, and participants in interactions.

Referring back to FIG. 16, the user support log file includes the customer utterances and the operator utterances stored in chronological order. The question utterance extraction section 122A checks the utterance sentences having utterance IDs arranged in chronological order, from the top. The operator utterances include fixed utterances at the top. The fixed utterances at the top (from utterances ID:1 to ID:3) can be preset to be removed without requiring any check. Thus, the check processing can be set to start at the fourth utterance. The question utterance extraction section 122A performs the check processing from the fourth utterance with the utterance classifying dictionary and specifies an extraction start position (processing (a) in FIG. 16).

In the example of FIG. 16, utterance sentences from utterance ID:4 to utterance ID:7 are determined to be non-question utterances. Then, an utterance sentence of an utterance ID:8 is determined not to be a non-question utterance, and the utterance ID:8 is specified as the extraction start position.

After the specification of the extraction start position, the question utterance extraction section 122A extracts a predetermined number of utterances subsequent to the start position as a question sentence unit (processing (b) in FIG. 16). For example, when the predetermined number N is set to 10, the question utterance extraction section 122A specifies an utterance ID:18 as an end position and extracts utterance sentences from utterances ID:8 to ID:18 as the question sentence unit.

It should be noted that the predetermined number N may be set to any number. For example, the history of customer-operator interactions can be previously analyzed through statistical processing, and the result of the analysis can be used to determine the range to be extracted as the question sentence unit.

Another implementation includes checking the utterances sequentially from the start position to see whether or not a particular greeting uttered by the operator is present and determining the particular greeting to be the end position, instead of using the predetermined number N. For example, the operator may say his name at the end of an interaction as “I’m OO in charge of customer support. Thank you for your continued support.” Such a sentence suggesting the end of the user support can be regarded as a special sentence which can be determined to be the end position, thereby defining the range to be extracted as the question sentence unit.

The question utterance extraction section 122A creates a user support log which consists of the extracted question sentence unit, that is, from which the utterance sentences having no information representing questioning have been removed, and outputs the created user support log to the grouping control section 122 (processing (c) in FIG. 16). The grouping control section 122 performs the grouping processing on the input user support log which has been subjected to the question utterance extraction processing.

It should be noted that utterance sentences in a user support log file of one customer may be segmented at predetermined time intervals and the question utterance extraction processing may be performed for each segment. In this case, the file may be divided into sub-files at predetermined time intervals and the processing may be performed for each sub-file, or the processing may be performed on the respective segments of the file in stages without dividing the file.

Conversely, a plurality of user support logs may be combined into one which in turn may be subjected to the question utterance extraction processing. In this case, user support logs may be combined into one according to conditions such as logs from the same customer, logs from the same operator, or logs during a predetermined time period being combined into one user support log, and then the processing may be performed on the one user support log.

The knowledge information creation assist system according to Embodiment 1 can create question groups from a large amount of user support logs to relieve the workload in creating FAQs corresponding to knowledge information. If too many question groups are created, it is troublesome to select an appropriate one from them. Especially, if many utterance sentence groups less related to questioning are present, an appropriate question group may be buried in those many question groups.

In the knowledge information creation assist system according to Embodiment 1, the question groups are created and displayed on their respective panels in the question group creation display block on the question group creation screen. Since the display area on the screen is limited, the user should scroll on the screen to see the many question groups. Considering the possibility of missing an appropriate question group, it is desirable to avoid display or creation of question groups less related to FAQ creation as much as possible.

In Embodiment 1, the question utterance extraction function can remove unnecessary utterance sentences to result in a reduction in number of question groups to be created in the grouping processing performed by the grouping control section 122.

For example, in the example of FIG. 16, the utterance of an utterance ID:7 includes keywords such as “buy a new car” or “review.” However, this utterance sentence includes no information representing questioning and corresponds to an utterance before specific questioning about buying a new car or about review, and is regarded as “having no information representing questioning” rather than as “having information representing questioning.” Thus, the utterance of the utterance ID:7 is not extracted as a question utterance sentence. This can prevent creation of a question group including “buy a new car” or “review.” Such an unnecessary question group is not created but a question group is created from “Are the insurance premiums of people in their fifties cheap?” Accordingly, the system can reduce the number of the displayed question groups in the display block to improve the operation efficiency in FAQ creation.

It should be noted that the extraction start position in the utterance sentences within the user support log file can be determined in response to an utterance of an operator, in addition to an utterance of a customer. An example of such an utterance of an operator is a question utterance sentence intended to promote a user to make a replay. For example, the operator says “You saw a commercial, so are you inquiring about the cheap insurance premiums of people in their fifties?” and the customer replies “Yes.” In this case, the phrase “are you inquiring about” can be registered as a set phrase in the utterance classifying dictionary and this set phrase can be fixedly specified (determined) to be the extraction start position.

The question utterance extraction function according to Embodiment 1 is summarized as follows.
(1) The question utterance extraction processing is processing of removing unnecessary utterance sentences not related to questioning from the user support log file or processing of extracting only utterance sentences related to questioning from the user support log file.
(2) The utterance classifying dictionary is used to determine whether or not one of the time-series utterance sentences included in the user support log file corresponds to an utterance having no information representing questioning, and in response to determining that the utterance sentence corresponds to an utterance having no information representing questioning, the utterance sentence is removed from the user support log file,
wherein, in response to finding any utterance sentence determined not to be an utterance having no information representing questioning (utterance having information), the processing of determining whether or not each utterance sentence corresponds to an utterance having no information representing questioning is skipped for a predetermined number of utterances subsequent to the found utterance sentence, and then the processing of determination is performed again from an utterance having an utterance ID equal to the predetermined number plus one.
(3) The utterance classifying dictionary is used to determine whether or not one of the time-series utterance sentences included in the user support log file corresponds to an utterance sentence having information representing questioning, and in response to determining that the utterance sentence corresponds to an utterance sentence having information representing questioning, a predetermined number of utterances subsequent to the utterance sentence are extracted as a question sentence unit.
(4) In (3) described above, the utterance sentence determined to have information representing questioning is specified as an extraction start position, extract a group of utterances that a predetermined number of utterances after the specified extraction start position as a question sentence unit or, determine a fixed sentence suggesting the end of an interaction as an end position, and extract a group of utterances from the extraction start position to the end position as the question sentence unit.
(5) In (4) described above, processing is again performed for determining whether or not each of the utterance sentences in the result of question utterance extraction corresponds to an utterance sentence having information representing questioning, in response to determining that one of the utterance sentences corresponds to an utterance having information representing questioning, newly determined utterance sentence is specified as a second extraction start position, extract a group of utterances that a predetermined number of utterances after the specified second extraction start position as a second question sentence unit or, determine a fixed sentence suggesting the end of an interaction as an end position, and extract a group of utterances from the second extraction start position to the end position as the second question sentence unit. This configuration can extract all the questions present in the first extracted question unit without fail. This can prevent any question from being buried in questions within the user support log file. The first question unit and the second question unit are input to the grouping control section 122 since both of them should be subjected to the grouping processing.
(6) In (1) to (5) described above, a predetermined number of utterance sentences from the top of the user support log file including time-series utterance sentences can be configured not to be subjected to the determination processing for removing or the determination processing for specifying the extraction start position.
(7) In (1) to (6) described above, the utterance classifying dictionary can include a first library including accumulated words, keywords, and exemplary utterances having no information representing questioning and a second library having accumulated words, keywords, and exemplary utterances including information representing questioning. Each of the first and second libraries can be formed as a customized library by taking account of the characteristics of individual utterers.
(8) In (2) to (7) described above, the question utterance extraction section 122A can be configured to be combined with the utterance classifying dictionaries to form utterance filter modules, and is configured to be formed a plurality of utterance filter modules formed according to each of the plurality of utterance classifying dictionaries.

The knowledge information creation assist system according to Embodiment 1 allows manual creation of FAQs from a large amount of user support logs without cumbersome operation to lower the cost in creating and maintaining the FAQs. Specifically, the question utterance extraction function according to Embodiment 1 can remove the unnecessary utterance sentences to reduce the number of question groups to be created. This can reduce the number of the displayed question groups in the display block to prevent any question group having information representing questioning from being buried in the question groups having no information representing questioning, thereby improving the operation efficiency in creating the FAQs.

While the embodiment has been described, the knowledge information creation assist apparatus 100 and the customer support management apparatus 330 may be implemented as an integrated computer system. In other words, the customer support management apparatus 330 may be configured to include the functions of the knowledge information creation assist described above.

The user terminal 500 includes a multi-functional cellular phone such as a smartphone, a mobile communication terminal apparatus such as a Personal Digital Assistant (PDA), and an information processing terminal apparatus such as a personal computer having a calling function, a communication function, and a computing function. Each of the operator terminal 300 and the manager terminal 350 is implemented by a computer apparatus equipped with a browser which performs processing of displaying the various screens described above.

The knowledge information creation assist apparatus 100 can include, as a hardware configuration, a memory (main storage apparatus), operation input means such as a mouse, keyboard, touch panel, and scanner, output means such as a printer, and an auxiliary storage apparatus (such as a hard disk), in addition to the components described above.

The functions of the present invention can be implemented by a program. A computer program previously provided for implementing each function can be stored on an auxiliary storage apparatus, the program stored on the auxiliary storage apparatus can be read by a control section such as a CPU to a main storage apparatus, and the program read to the main storage apparatus can be executed by the control section to allow a computer to perform the function of each component in the present invention. Each of the functions of the present invention can also be implemented by a different one of apparatuses, and those apparatuses can be connected directly or via a network to constitute a computer system.

The program may be recorded on a computer readable recording medium and provided for the computer. Examples of the computer readable recording medium include optical disks such as a CD-ROM, phase-change optical disks such as a DVD-ROM, magneto-optical disks such as a Magnet-Optical (MO) disk and Mini Disk (MD) , magnetic disks such as a floppy disk® and removable hard disk, and memory cards such as a compact flash®, smart media, SD memory card, and memory stick. Hardware apparatuses such as an integrated circuit (such as an IC chip) designed and configured specifically for the purpose of the present invention are included in the recording medium.

While the embodiment of the present invention has been described, the embodiment is only illustrative and is not intended to limit the scope of the present invention. The novel embodiment can be implemented in various other forms, and various omissions, substitutions, and modifications can be made thereto without departing from the spirit or scope of the present invention. The embodiment and its variations are encompassed within the spirit or scope of the present invention and within the invention set forth in the claims and the equivalents thereof.

### Description of the Reference Numerals

| | |
|---|---|
| 100 | KNOWLEDGE INFORMATION CREATION ASSIST APPARATUS |
| 110 | COMMUNICATION CONTROL APPARTAUS |
| 120 | CONTROL APPARATUS |
| 121 | USER SUPPORT LOG INPUT CONTROL SECTION |
| 122 | GROUPING CONTROL SECTION |
| 122A | QUESTION UTTERANCE EXTRACTION SECTION |
| 123 | SCREEN CONTROL SECTION |
| 124 | EXISTING FAQ ASSOCIATION CONTROL SECTION |
| 125 | KNOWLEDGE INFORMATION CREATION SECTION |
| 126 | OUTPUT CONTROL SECTION |
| 130 | STORAGE APPARATUS |
| 300 | OPERATOR TERMINAL |
| 330 | CUSTOMER SUPPORT MANAGEMENT APPARATUS |
| 350 | MANAGER TERMINAL |
| 500 | USER TERMINAL |

1. A knowledge information creation assist apparatus for providing a function of assisting creation of knowledge information related to questioning, comprising:
an input control section configured to control upload of a plurality of user support histories including questions;
a question utterance extraction section configured to perform processing of removing at least one unnecessary utterance sentence not related to questioning from the uploaded user support histories or processing of extracting at least one utterance sentence related to questioning from the user support histories and then output the resulting user support histories as a result of the processing;
a grouping control section configured to classify the user support histories output as the result of the processing from the question utterance extraction section into a plurality of question groups according to a predetermined classification model; and
a screen control section configured to perform first display control for displaying, on a display apparatus, a question group creation screen including group information of each of the question groups and second display control for displaying, on the display apparatus, a knowledge information creation screen for producing knowledge information in response to input performed by a creator to one of the question groups selected on the question group creation screen.

2. The knowledge information creation assist apparatus according to claim 1, wherein the question utterance extraction section is configured to use an utterance classifying dictionary to determine whether or not one of time-series utterance sentences included in the user support histories corresponds to an utterance having no information representing questioning, and in response to determining that the utterance sentence corresponds to an utterance having no information representing questioning, remove the utterance sentence from the user support histories.

3. The knowledge information creation assist apparatus according to claim 1, wherein the question utterance extraction section is configured to use an utterance classifying dictionary to determine whether or not one of time-series utterance sentences included in the user support histories corresponds to an utterance sentence having information representing questioning, and in response to determining that the utterance sentence corresponds to an utterance sentence having information representing questioning, extract a predetermined number of utterances subsequent to the utterance sentence as a question sentence unit.

4. The knowledge information creation assist apparatus according to claim 3, wherein the question utterance extraction section is configured to specify the utterance sentence determined to have information representing questioning as an extraction start position, extract a group of utterances that a predetermined number of utterances after the specified extraction start position as the question sentence unit or, determine a fixed sentence suggesting an end of an interaction as an end position and extract a group of utterances from the extraction start position to the end position as a question sentence unit.

5. The knowledge information creation assist apparatus according to claim 4, wherein the question utterance extraction section is configured to further perform processing of determining whether or not each of the utterance sentences output as the result of the processing is an utterance sentence having information representing questioning, in response to newly determining that one of the utterance sentences corresponds to an utterance having information representing questioning, specify newly determined utterance sentence as a second extraction start position, extract a group of utterances that a predetermined number of utterances after the specified second extraction start position as a second question sentence unit or, determine a fixed sentence suggesting an end of an interaction as an end position and extract a group of utterances from the second extraction start position to the end position as the second question sentence unit.

6. The knowledge information creation assist apparatus according to claim 1 , wherein the question utterance extraction section is configured to perform processing such that a predetermined number of utterance sentences from the top of the user support histories are not output to the grouping control section.

7. The knowledge information creation assist apparatus according to claim 2 , wherein the utterance classifying dictionary includes a first library including accumulated words, keywords, and exemplary utterances having no information representing questioning and a second library including accumulated words, keywords, and exemplary utterances having information representing questioning.

8. The knowledge information creation assist apparatus according to claim 2 , wherein the utterance classifying dictionary comprises a plurality of utterance classifying dictionaries, and the question utterance extraction section is configured to be combined with the utterance classifying dictionaries to form utterance filter modules, and is configured to be formed a plurality of utterance filter modules formed according to each of the plurality of utterance classifying dictionaries.

9. The knowledge information creation assist apparatus according to claim 1 , wherein the grouping control section is configured to create a representative question sentence and a keyword of each of the question groups by using the user support histories classified as belonging to the question group, and
the screen control section is configured to display the group information in the first display control such that the group information includes the representative sentence and the keyword.

10. A non-transitory computer readable medium including a computer executable program for providing a function of assisting creation of knowledge information related to questioning, the program comprising instructions which, when executed by a computer, cause the computer to perform:
a function of controlling upload of a plurality of user support histories including questions;
a function of performing processing of removing at least one unnecessary utterance sentence not related to questioning from the uploaded user support histories or processing of extracting at least one utterance sentence related to questioning from the user support histories and then outputting the resulting user support histories as a result of the processing;
a function of classifying the user support histories output as the result of the processing into a plurality of question groups according to a predetermined classification model;
a function of performing first display control for displaying, on a display apparatus, a question group creation screen including group information of each of the question groups and second display control for displaying, on the display apparatus, a knowledge information creation screen for producing knowledge information in response to input performed by a creator to one of the question groups selected on the question group creation screen; and
a function of producing output data of the knowledge information created for each of the question groups on the knowledge information creation screen.

11. A knowledge information creation assist system for providing a function of assisting creation of knowledge information related to questioning, comprising:
an input control section configured to receive a plurality of user support histories including questions in response to upload operation on a terminal of a creator creating knowledge information;
a question utterance extraction section configured to perform processing of removing at least one unnecessary utterance sentence not related to questioning from the uploaded user support histories or processing of extracting at least one utterance sentence related to questioning from the user support histories and then output the resulting user support histories as a result of the processing;
a grouping control section configured to classify the user support histories output as the result of the processing from the question utterance extraction section into a plurality of question groups according to a predetermined classification model;
a screen control section configured to perform first display control for displaying, on the terminal, a question group creation screen including group information of each of the question groups and second display control for displaying, on the terminal, a knowledge information creation screen for producing knowledge information in response to input performed by the creator to one of the question groups selected on the question group creation screen; and
an output control section configured to produce and output output data of the knowledge information created for each of the question groups on the knowledge information creation screen in response to download operation on the terminal.
